(19) United States
(12) Patent Application Publication
(10) Pub. No.: US 2012/0242248 A1
(43) Pub. Date: Sep. 27, 2012

(54) LIGHTING CONTROL DEVICE AND LIGHTING CONTROL MODULE

(76) Inventors: Rhys John DRUMMOND, QLD (AU); Michael Joseph WALSH, QLD (AU); Phillip John DIVER, QLD (AU); Raymond Lindsay HOPE, QLD (AU); Duncan Bartlett GILMORE, QLD (AU)

(21) Appl. No.: 13/069,807

(22) Filed: Mar. 23, 2011

(51) Int. Cl. H05B 37/02

(52) U.S. Cl. 315/297

(57) ABSTRACT

The invention discloses a lighting control module, suitable for controlling a lighting device. The plate of the lighting control module is detachably assembled with the lighting control device. In the lighting control device, a microprocessor commands a power phase control circuit to control the lighting device according to a touch signal sensed by a touch sensing module and controls an indicating light module according the brightness of the lighting device.

### BACKGROUND OF THE INVENTION

(a) Field of the Invention

The invention relates to a lighting control device and a lighting control module, particularly to a touch sensing type lighting control device and lighting control module.

(b) Description of the Related Art

FIG. 1 shows a three-dimensional view of a light switching device according to the prior art. As shown in FIG. 1, the light switching device 1 comprises a switch body 11, a pressing plate 12 and a cover plate 15. The cover plate 15 defines an opening and the pressing plate 12 is disposed in the opening and connected to the switch body 11. The conventional light switching device 1 is a mechanical structure and the pressing plate 12 is switched between a turned-on state and a turned-off state to control the switch body 11. In addition, the area of the above opening should be larger than that of the pressing plate 12 to maintain some gap between the pressing plate 12 and the cover plate 15 in order to prevent the pressing plate 12 from being stuck in the above opening.

Generally, the light switching device 1 is installed in the wall to be pressed by a user for turning on or off (not shown). For example, in a public place such as a hotel or hospital, the light switching device 1 is frequently pressed by different users and thus it is required frequently cleaned to avoid the transmission of bacteria. However, there is some gap between the pressing plate 12 and the cover plate 15 of the light switching device 1 and thus during cleaning a cleaning solution will flow into the gap to damage circuits in the switch body 11 and also to increase the inconvenience during cleaning.

Furthermore, in an artistic-stressed environment such as a hotel, the pattern of the light switching device 1 cannot be arbitrarily changed to be integrated into design by a designer so that the light switching device 1 is lacked of design flexibility. Therefore, the conventional light switching device 1 can be further improved.

### BRIEF SUMMARY OF THE INVENTION

One object of the invention is to provide a touch sensing type lighting control device and module. One object of the invention is to provide a touch sensing type lighting control device and module capable of recovering to the brightness value that is stored previously. One object of the invention is to provide a touch sensing type lighting control module being convenient for plate replacement.

One embodiment of the invention provides a lighting control device being suitable for controlling a lighting device. The lighting control device comprises a touch sensing module, an indicating light module, a power phase control circuit, and a microprocessor.

The touch sensing module comprises a first touch sensor and a second touch sensor. The first and second touch sensors are capable of sensing a touch state to generate a touch signal. The indicating light module comprises a plurality of light emitting diode (LED) units. The power phase control circuit controls brightness of the lighting device. The microprocessor comprises a register. The register stores a brightness value of the lighting device and the microprocessor controls the power phase control circuit according to the touch signal and determines which of the light emitting diode units are associated according to the brightness value of the lighting device. When the first touch sensor and the second sensor simultaneously sense a touch, the microprocessor commands the power phase control circuit to turn on the lighting device and adjust the brightness of the lighting device to the brightness value according to the brightness value of the lighting device stored in the register and the indicating light module turns on the associated light emitting diode units and adjusts the brightness of the associated light emitting diode units according to the brightness value of the lighting device. When only the first touch sensor senses a touch and the duration of the touch is less than a first predetermined touch time, the microprocessor controls the power phase control circuit to gradually turn on the lighting device within a second predetermined time and the microprocessor controls the indicating light module to turn on the associated light emitting diode units and adjust the brightness of the associated light emitting diode units according to the brightness value of the lighting device. When only the second touch sensor senses a touch and the duration of the touch is less than a third predetermined touch time, the microprocessor controls the power phase control circuit to gradually turn off the lighting device within a fourth predetermined time and the microprocessor controls the indicating light module to turn on the associated light emitting diode units and adjust the brightness of the associated light emitting diode units according to the brightness value of the lighting device.

According to one embodiment of the invention, a lighting control module is provided. The lighting control module is suitable to control a lighting device and comprises a lighting control device and a plate. The plate is detachably assembled with the lighting control device and the plate comprises a first touch area, a second touch area and an indicating light area. The position of the first touch sensor corresponds to that of the first touch area, the position of the second touch sensor corresponds to that of the second touch area, and the position of the light emitting diode (LED) units corresponds to that of the indicating light area.

In one embodiment, when only the first touch sensor senses a touch and the duration of the touch is larger than or equal to the first predetermined touch time, the microprocessor controls the power phase control circuit to increase the brightness of the lighting device and then stores the increased brightness value in the register as a brightness value of the lighting device; and when only the second touch sensor senses a touch and the duration of the touch is larger than or equal to the third predetermined touch time, the microprocessor controls the power phase control circuit to decrease the brightness of the lighting device and then stores the decreased brightness value in the register as a brightness value of the lighting device.

In one embodiment, when the first touch sensor and the second sensor both do not sense a touch within a delay period, the microprocessor controls the indicating light module to decrease the brightness of the associated light emitting diode units to a brightness value for a power saving mode.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 shows a three-dimensional view of a light switching device according to the prior art.

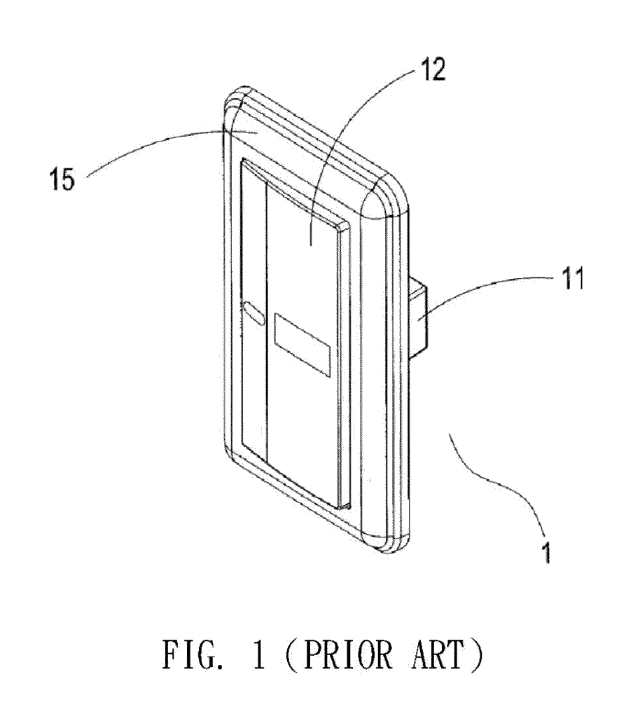

FIG. 2A shows a schematic diagram illustrating an opening on a wall to accommodate the lighting control device according to one embodiment of the invention.

FIG. 2B shows a front-view schematic diagram while a glass plate and a lighting control device are assembled according to one embodiment of the invention.

FIG. 2C shows a back-view schematic diagram while a glass plate and a lighting control device are assembled according to one embodiment of the invention.

FIG. 3 shows a schematic diagram illustrating a glass plate according to one embodiment of the invention.

FIG. 4 shows a functional block diagram illustrating a lighting control device according to another embodiment of the invention.

FIG. 5A shows a flow chart illustrating a lighting control method according to one embodiment of the invention.

FIG. 5B shows a flow chart illustrating a lighting control method according to one embodiment of the invention.

FIG. 6 shows a flow chart illustrating a lighting control method according to one embodiment of the invention.

### DETAILED DESCRIPTION OF THE INVENTION

In the following detailed description of the preferred embodiments, reference is made to the accompanying drawings which form a part hereof; and in which is shown by way of illustration specific embodiments in which the invention may be practiced. In this regard, directional terminology is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” and variations thereof herein are used broadly and encompass direct and indirect connections, couplings, and mountings. Similarly, “touch” and “adjacent to” and variations thereof herein are used broadly and encompass directly and indirectly “adjacent to”. Therefore, the description of “A” component “touches” “B” component herein may contain the situations that “A” component is “adjacent to” or “in contact with” “B” component; the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

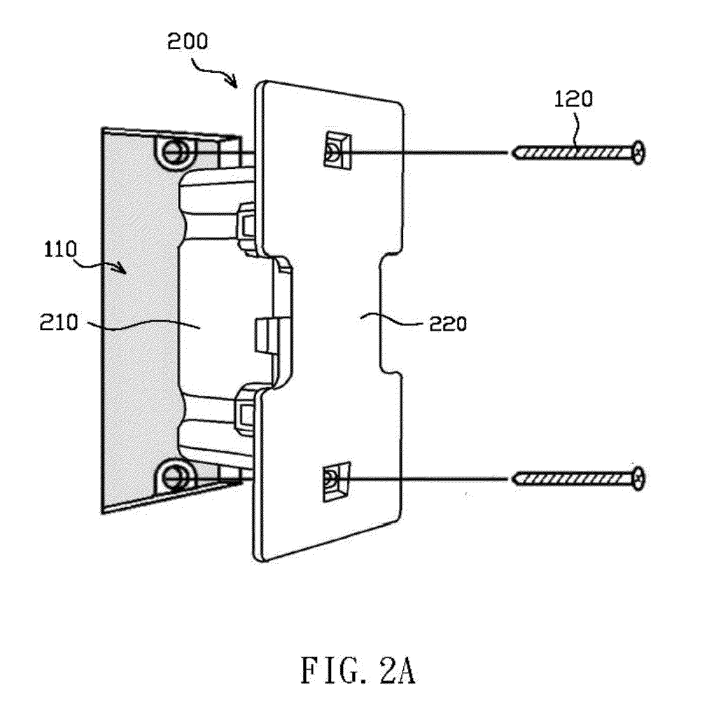

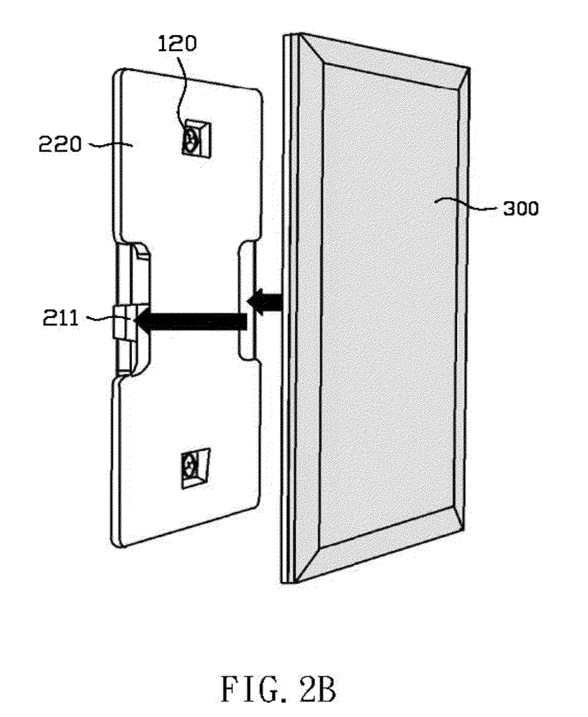

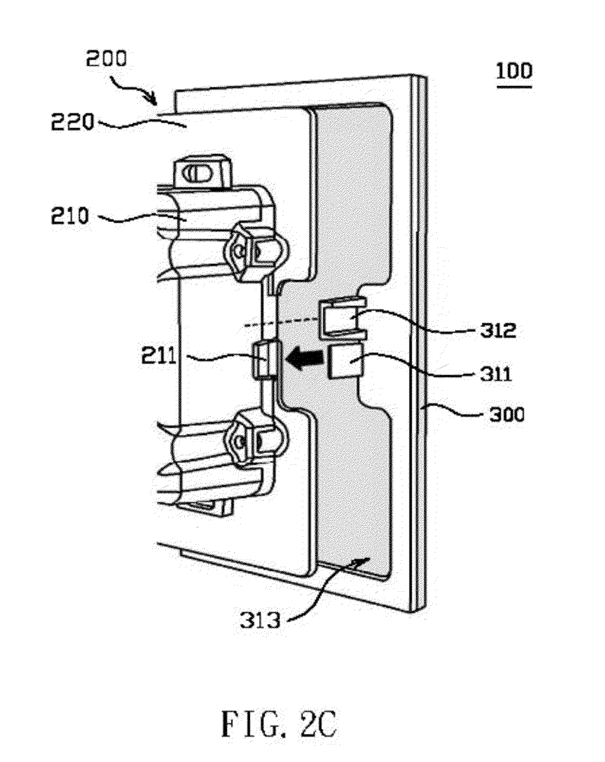

FIG. 2A shows a schematic diagram illustrating an opening on a wall to accommodate the lighting control device according to one embodiment of the invention. FIG. 2B shows a front-view schematic diagram while a glass plate and a lighting control device are assembled according to one embodiment of the invention. FIG. 2C shows a back-view schematic diagram while a glass plate and a lighting control device are assembled according to one embodiment of the invention.

As shown in FIG. 2C, the lighting control module 100 according to one embodiment of the invention comprises a lighting control device 200 and a glass plate 300. The lighting control device 200 comprises a housing 210 and a cover plate 220. The housing 210 is disposed on the back side of the cover plate 220 and part of electronic elements (to be described later) of the lighting control device 200 are disposed in the housing 210 in order to protect the electronic elements.

As shown in FIG. 2A, when the lighting control module 100 is to be installed on the wall, the lighting control device 200 is firstly disposed in an opening 110 defined by the wall and a plurality of screws 120 are used to mount the lighting control device 200 on the wall.

As shown in FIG. 2B, the glass plate 300 is then detachably installed on the lighting control device 200. In this embodiment, at least one side of the cover plate 220 is provided with a first hook slip element 211. As shown in FIG. 2C, the back surface of the glass plate 300 is provided with a second hook slip element 311. Through the engagement of the first and second hook slip elements 211 and 311, the glass plate 300 is mounted on the lighting control device 200. When the glass plate 300 needs to be replaced, it only requires pulling the glass plate 300 to have the second hook slip element 311 separated from the first hook slip element 211 to detach the glass plate. Then, a new glass plate 300 may be disposed to replace the old one. By such design, as the wall paper on the above mentioned wall is to be replaced or the design pattern on the wall is to be changed, a new glass plate 300 can be simply replaced without replacing a whole lighting control module 100.

Further referring to FIG. 2C, the back surface of the glass plate 300 further defines an accommodation space 313 and the cover plate 220 is disposed in the accommodation space 313. According to the above design, since the glass plate 300 has a flat surface, a cleaning solution while cleaning the lighting control module 100 will not erode the circuits and electronic elements inside the lighting control module 100.

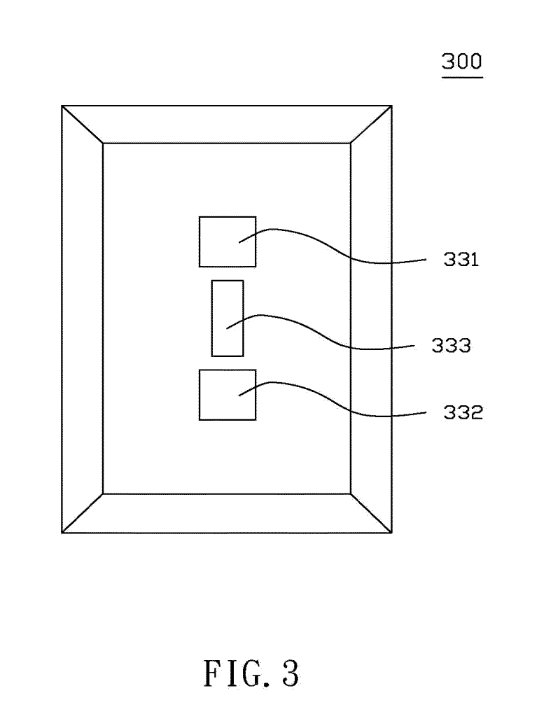

FIG. 3 shows a schematic diagram illustrating a glass plate according to one embodiment of the invention. As shown in FIG. 3, the glass plate 300 is provided with a first touch area 331, a second touch area 332 and an indicating light area 333. In this embodiment, the shapes of the first touch area 331, the second touch area 332 and the indicating light area 333 are squares used as an example for illustration but the invention is not limited to this example. The pattern of the glass plate 300 can be designed by a user himself. Preferably, the pattern on the surface of the glass plate 300 is designed based on the pattern and colors of the wall.

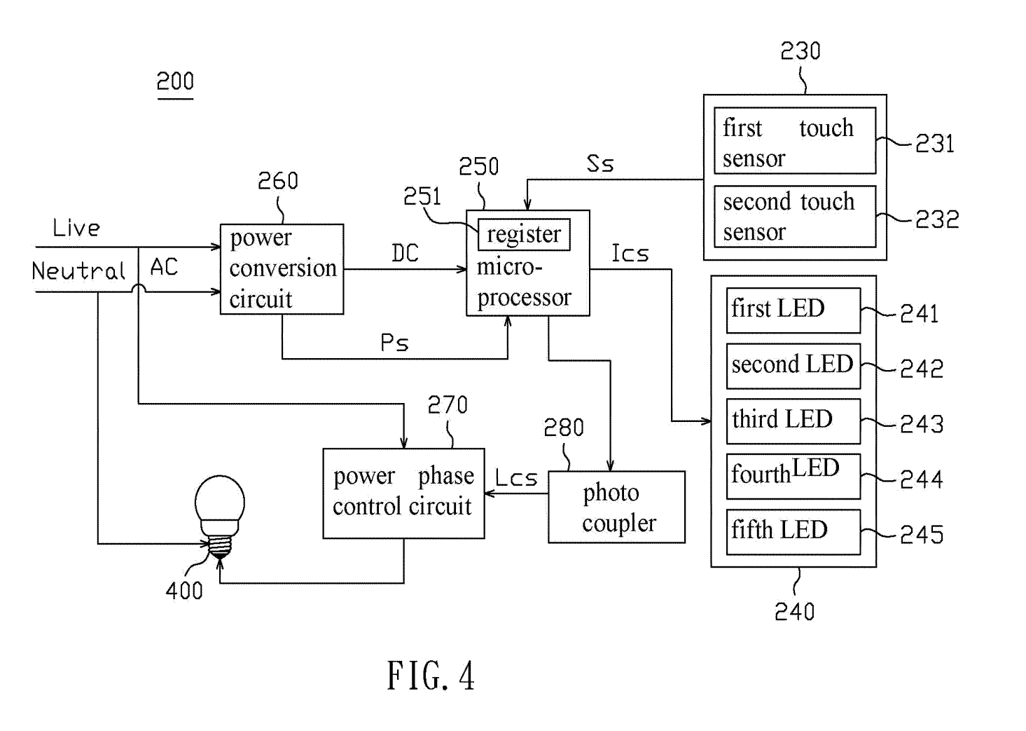

FIG. 4 shows a functional block diagram illustrating a lighting control device according to another embodiment of the invention. As shown in FIG. 4, the lighting control device 200 comprises a touch sensing module 230, an indicating light module 240, a microprocessor 250, a power conversion circuit 260, a power phase control circuit 270, and a photo coupler 280. The cover plate 220 is formed by providing a plastic plate on a printed circuit board and the above mentioned electronic elements are coupled to the circuits on the cover plate 220 and are coupled to each other through the cover plate 220. A portion of the electronic elements are disposed on the front surface of the cover plate 220 and a portion of the electronic elements are disposed on the back surface of the cover plate 220 in the housing 210. In one embodiment, the touch sensing module 230 is disposed on the front surface of the cover plate 220. One of ordinary skill in the art should be able to allocate the above electronic elements according to product design and thus the description of their detailed allocation will be omitted in the following.

The power conversion circuit 260 is used to convert an external alternating current (AC) power source into a direct current (DC) power source and is coupled to the microprocessor 250 to supply the microprocessor 250 with a 5V DC power source and a phase sensing signal Ps. The microprocessor 250 is coupled to the touch sensing module 230 and outputs a brightness control signal Lcs and an indicating control signal Ics according to the touch signal sensed from the touch sensing module 230.

In this embodiment, in order to protect the microprocessor 250, the photo coupler 280 is coupled between the microprocessor 250 and the power phase control circuit 270. The microprocessor 250 transmits a brightness control signal Lcs through the photo coupler 280 to the power phase control circuit 270.

An external lighting device 400 is coupled to the live and the neutral lines of the alternating current (AC) power source through the power phase control circuit 270 of the lighting control device 200. The power phase control circuit 270 receives the brightness control signal Lcs from the microprocessor 250 and controls the brightness of the lighting device 400 according to the brightness control signal Lcs. The indicating light module 240 comprises a plurality of light emitting diodes (LED) to indicate the state of the brightness of the lighting device 400. The indicating light module 240 receives the indicating control signal Ics from the microprocessor 250, turns on the associated LEDs according to the indicating control signal Ics, and adjusts the brightness of the associated LEDs.

In this embodiment, the touch sensing module 230 comprises a first and second touch sensor 231 and 232 and the above touch sensors are capacitive touch sensors. The indicating light module 240 comprising five LEDs (the first LED 241˜the fifth LED 245) is used as an example to be illustrated in the following. When the lighting control device 200 and the glass plate 300 are assembled together, the position of the first touch sensor 231 corresponds to that of the first touch area 331, the position of the second touch sensor 232 corresponds to that of the second touch area 332, and the position of the indicating light module 240 corresponds to that of the indicating light area 333. Therefore, when a user touches the first and second touch areas 331 and 332, they sense a touch and output a touch signal. Note that, the description of “A touches B” herein may contain the situations that “A is adjacent to or in contact with B” or the situations that make the touch sensors output a touch signal.

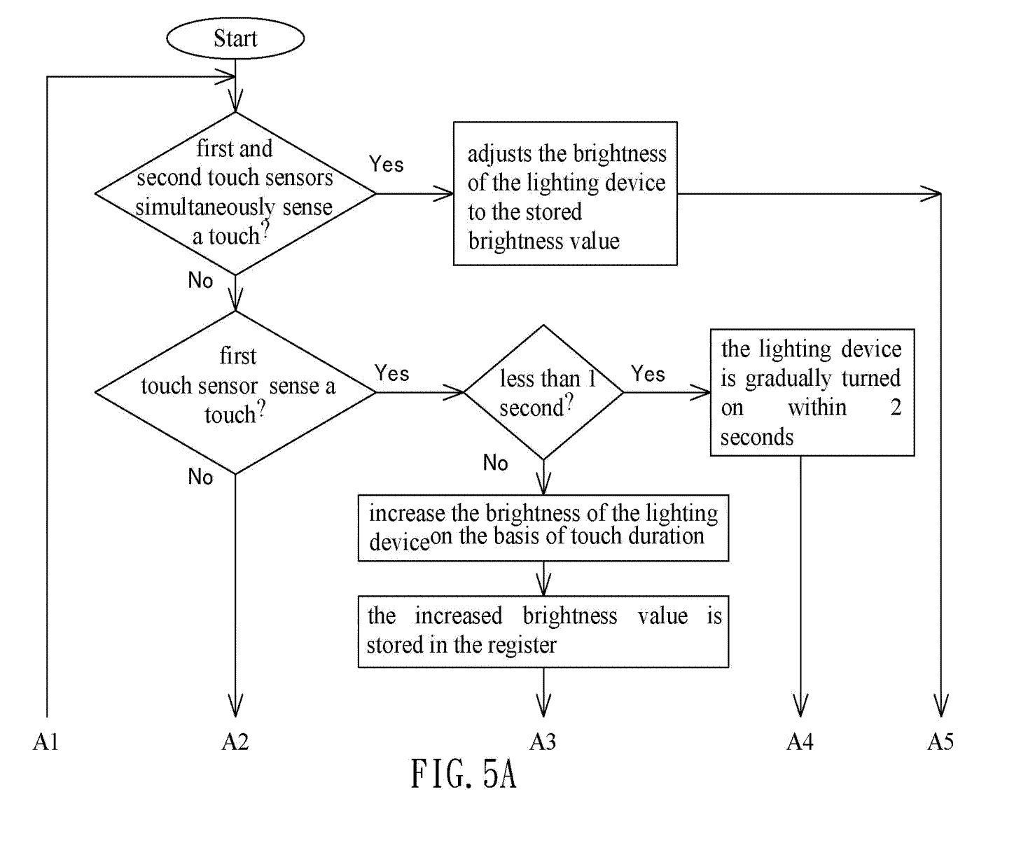

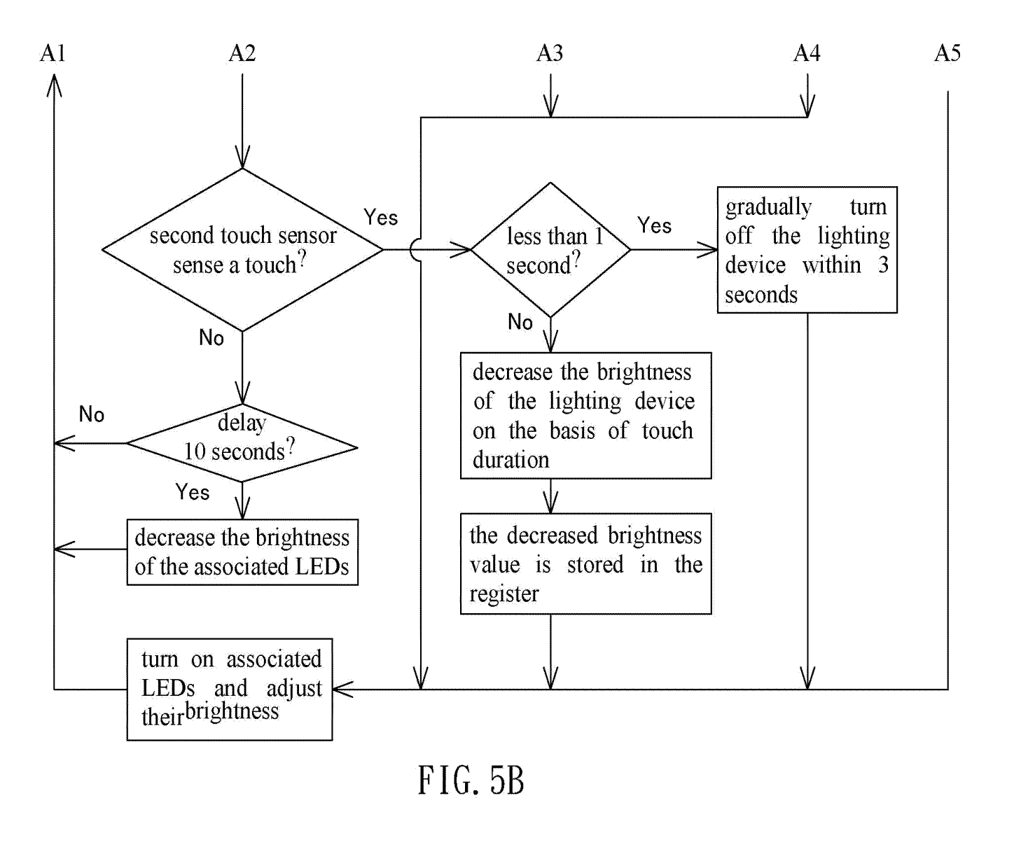

FIGS. 5A and 5B shows a flow chart illustrating a lighting control method according to one embodiment of the invention. As shown in FIGS. 5 A and 5B, the microprocessor 250 determines the touch state of the touch sensing module 230 according to the touch signal sensed by the touch sensing module 230.

When the first and second touch sensors 231 and 232 simultaneously sense a touch, the power phase control circuit 270 turns on the lighting device 400 according to the brightness value stored in the register 251 and adjusts the brightness of the lighting device 400 to the stored brightness value and the indicating light module 240 turns on the associated light emitting diodes (LEDs) and adjusts the brightness of the associated LEDs according to the above mentioned stored brightness value.

Specifically, according to the stored brightness value, the microprocessor 250 generates a brightness control signal Lcs and an indicating control signal Ics showing the stored brightness value and determines associated LEDs. The power phase control circuit 270 receives the brightness control signal Lcs showing the stored brightness value through the photo coupler 280, turns on the lighting device 400, and adjusts the brightness of the lighting device 400 to the stored brightness value. The indicating light module 240 receives the indicating control signal Ics showing the stored brightness value, turns on the associated LEDs, and adjusts the brightness of the associated LEDs.

In one embodiment, the number of LEDs being turned on is directly proportioned to the brightness of the lighting device 400. For example, when the lighting device 400 is turned off, the first LED 241 is turned on; when the lighting device 400 is at the maximum brightness (100%), the first LED 241˜the fifth LED 245 are turned on; when the lighting device 400 is at 60% of the maximum brightness, the first LED 241˜the third LED 243 are turned on; and the brightness of the first LED 241 is larger than the second LED 242 and larger than the third LED 243 so that the brightness of the LED units are under a gradient state in the magnitude of brightness. In addition, when the first and second touch sensors 231 and 232 do not sense any touch within a period of 10 seconds, the brightness of the LEDs are dimmed.

As the description in the above, the method is described in details that the microprocessor 250 uses the brightness control signal Lcs and the indicating control signal Ics to control the power phase control circuit 270 and the touch sensing module 230. Therefore, the following will omit the detailed description of the similar steps.

Please refer to FIGS. 5A and 5B again. When only the first touch sensor 231 senses a touch and the duration of the touch is less than 1 second (a first predetermined touch time), the microprocessor 250 controls the power phase control circuit 270 to gradually turn on the lighting device within 2 seconds (a second predetermined time) and the microprocessor 250 controls the indicating light module 240 to turn on the associated LEDs and adjust the brightness of the associated LEDs according to the brightness value of the lighting device 400. In this embodiment, the lighting device 400 is gradually turned on within 2 seconds so that a user senses the variation of the brightness of the lighting device 400. In another embodiment, the second predetermined time can be set to substantially zero second.

When only the first touch sensor 231 senses a touch and the duration of the touch is larger than or equal to 1 second (the first predetermined touch time), the microprocessor 250 controls the power phase control circuit 270 to increase the brightness of the lighting device 400. Then, the increased brightness value is stored in the register 251. Finally, the microprocessor 250 controls the indicating light module 240 to turn on the associated LEDs and adjust the brightness of the associated LEDs according to the brightness value of the lighting device 400.

When only the second touch sensor 232 senses a touch and the duration of the touch is less than 1 second (a third predetermined touch time), the microprocessor 250 controls the power phase control circuit 270 to gradually turn off the lighting device 400 within 3 seconds (a fourth predetermined time) and the microprocessor 250 controls the indicating light module 240 to turn on the associated LEDs and adjust the brightness of the associated LEDs according to the brightness value of the lighting device 400. Specifically, at the time, the lighting device 400 is turned off and the brightness of the lighting device 400 is zero. Therefore, the first LED unit 241 is turned on to indicate a user the position of the lighting control module 100. In this embodiment, the lighting device 400 is gradually turned off within 3 seconds so that a user senses the variation of the brightness of the lighting device 400.

When only the second touch sensor 232 senses a touch and the duration of the touch is larger than or equal to 1 second (the third predetermined touch time), the microprocessor 250 controls the power phase control circuit 270 to decrease the brightness of the lighting device 400. Then, the decreased brightness value is stored in the register 251. Finally, the microprocessor 250 controls the indicating light module 240 to turn on the associated LEDs and adjust the brightness of the associated LEDs according to the brightness value of the lighting device 400.

When the first and second touch sensors 231 and 232 both do not sense a touch within 10 seconds (a delay period), the microprocessor 250 controls the indicating light module 240 to decrease the brightness of the associated LEDs to a brightness value for a power saving mode so that the indicating light module 240 is under a power saving mode to save power.

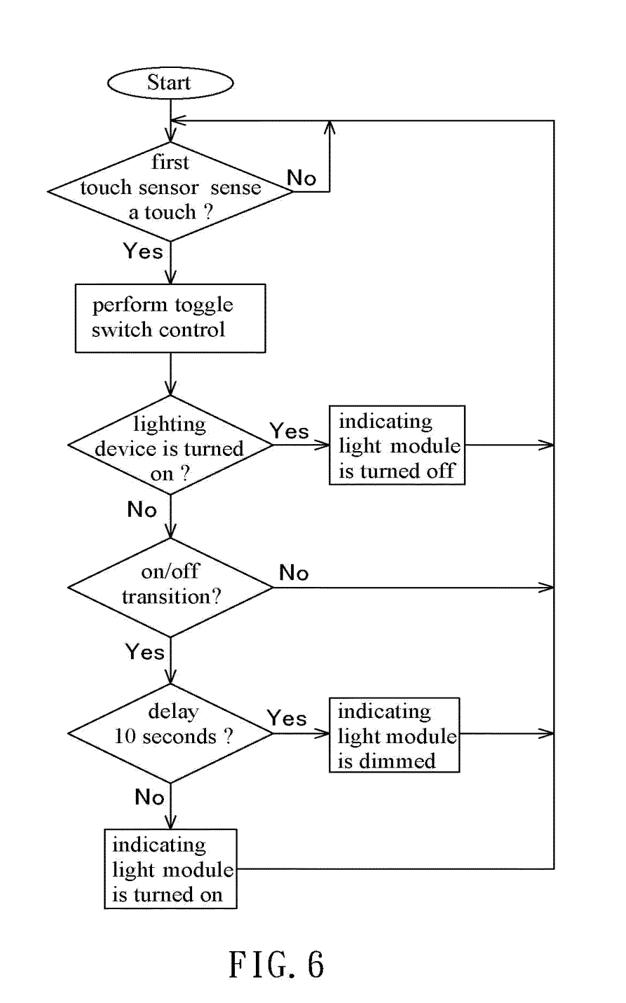

FIG. 6 shows a flow chart illustrating a lighting control method according to one embodiment of the invention. In this embodiment, the light dimming control may not be performed and only the switching control of the lighting device 400 is carried out. For such an embodiment, a touch area and a touch sensor can control a lighting device. The following uses the first touch area 331 and the first touch sensor 231 to control the lighting device 400 as an example for illustration.

As shown in FIG. 6, when the first touch sensor 231 senses a touch, the microprocessor 250 controls the power phase control circuit 270 to perform toggle switch control, that is, to turn on the lighting device 400 when the lighting device 400 is turned off and to turn off the lighting device 400 when the lighting device 400 is turned on.

Thereafter, it is determined whether the lighting device 400 is turned on or not. If the lighting device 400 is turned on, the indicating light module 240 is turned off; and if the lighting device 400 is turned off, it is determined whether the lighting device 400 is under on/off transition or not. If yes and when the delay period is within 10 seconds, the indicating light module 240 is turned on. If yes and when the delay period exceeds 10 seconds, the brightness of the LED units in the indicating light module 240 are dimmed.

As the description in the above, according to the lighting control module 100 in one embodiment of the invention, the glass plate 300 can be easily replaced to cooperate with the pattern and colors of the wall. In one embodiment, when the lighting control module 100 is to be cleaned, a cleaning solution will not erode the circuits and electronic elements on the cover plate 220 to reduce the damage of the lighting control module 100. In one embodiment, the lighting control module 200 can recover the previously stored brightness value of the lighting device according the habit of a user to simplify the process of turning on the lighting device 400 by the user. In additional, even though the fingers of users may not be in contact with (only be adjacent to) the touch areas, the touch sensors can sense a touch. As a result, the present invention may have an advantage of preventing contagious disease between users when the lighting control module 100 is used in a hospital.

Although the present invention has been fully described by the above embodiments, the embodiments should not constitute the limitation of the scope of the invention. Various modifications or changes can be made by those who are skilled in the art without deviating from the spirit of the invention. Any embodiment or claim of the present invention does not need to reach all the disclosed objects, advantages, and uniqueness of the invention. Besides, the abstract and the title are only used for assisting the search of the patent documentation and should not be construed as any limitation on the implementation range of the invention.

What is claimed is:

1. A lighting control module, suitable for controlling a lighting device, the lighting control module comprising: a lighting control device and a plate wherein the plate is detachably assembled with the lighting control device and the plate comprises a first touch area, a second touch area and an indicating light area, and the lighting control device comprises:
a touch sensing module, comprising a first touch sensor and a second touch sensor wherein the position of the first touch sensor corresponds to that of the first touch area, the position of the second touch sensor corresponds to that of the second touch area, and the first touch sensor and the second touch sensor are capable of sensing a touch state to generate a touch signal;
an indicating light module, comprising a plurality of light emitting diode (LED) units, the position of which corresponds to the position of the indicating light area;
a power phase control circuit, for controlling brightness of the lighting device; and
a microprocessor, comprising a register wherein the register stores a brightness value of the lighting device and the microprocessor controls the power phase control circuit according to the touch signal and determines which of the light emitting diode units are associated according to the brightness value of the lighting device;
wherein, when the first touch sensor and the second sensor simultaneously sense a touch, the microprocessor commands the power phase control circuit to turn on the lighting device according to the brightness value of the lighting device stored in the register and adjust the brightness of the lighting device to the brightness value and the indicating light module turns on the associated light emitting diode units and adjusts the brightness of the associated light emitting diode units according to the brightness value of the lighting device;
when only the first touch sensor senses a touch and the duration of the touch is less than a first predetermined touch time, the microprocessor controls the power phase control circuit to gradually turn on the lighting device within a second predetermined time and the microprocessor controls the indicating light module to turn on the associated light emitting diode units and adjust the brightness of the associated light emitting diode units according to the brightness value of the lighting device; and
when only the second touch sensor senses a touch and the duration of the touch is less than a third predetermined touch time, the microprocessor controls the power phase control circuit to gradually turn off the lighting device within a fourth predetermined time and the microprocessor controls the indicating light module to turn on the associated light emitting diode units and adjust the brightness of the associated light emitting diode units according to the brightness value of the lighting device.

2. The lighting control module according to claim 1, wherein,
when only the first touch sensor senses a touch and the duration of the touch is larger than or equal to the first predetermined touch time, the microprocessor controls the power phase control circuit to increase the brightness of the lighting device and then stores the increased brightness value in the register as a brightness value of the lighting device; and
when only the second touch sensor senses a touch and the duration of the touch is larger than or equal to the third predetermined touch time, the microprocessor controls the power phase control circuit to decrease the brightness of the lighting device and then stores the decreased brightness value in the register as a brightness value of the lighting device.

3. The lighting control module according to claim 1, wherein,
when the first touch sensor and the second sensor both do not sense a touch within a delay period, the microprocessor controls the indicating light module to decrease the brightness of the associated light emitting diode units to a brightness value for a power saving mode.

4. The lighting control module according to claim 1, wherein the plate comprises at least a second engaging element provided on a back surface of the plate, the lighting control device further comprises a cover plate, at least one side of the cover plate is provided with a first engaging element, and the plate is detachably assembled with the lighting control device through the engagement between the first engaging element and the second engaging element.

5. The lighting control module according to claim 4, wherein the back surface of the plate further defines an accommodating space and the cover plate is disposed in the accommodating space.

6. The lighting control module according to claim 4, wherein the touch sensing module, the indicating light module, the power phase control circuit, and the microprocessor are electrically coupled to each other through a circuit board, the first predetermined touch time is equal to the third predetermined touch time, and the fourth predetermined time is larger than the second predetermined time.

7. The lighting control module according to claim 4, wherein the plate is a glass plate or an non-conductive plate.

8. A lighting control module, suitable for controlling a lighting device, the lighting control module comprising:
a lighting control device comprising at least a touch sensor; and
a plate comprising at least a touch area,
wherein the plate is detachably assembled with the lighting control device; the position of the touch sensor corresponds to that of the touch area, and
when an object is adjacent to or in contact with the touch area, the touch sensor senses a touch state to generate a touch signal, so that the lighting control device controls the lighting device according to the touch signal.

9. A lighting control device, suitable for controlling a lighting device, comprising:
a touch sensing module, comprising a first touch sensor and a second touch sensor, wherein the first touch sensor and the second touch sensor are capable of sensing a touch state to generate a touch signal;
an indicating light module, comprising a plurality of light emitting diode (LED) units;
a power phase control circuit, for controlling brightness of the lighting device; and
a microprocessor, comprising a register wherein the register stores a brightness value of the lighting device and the microprocessor controls the power phase control circuit according to the touch signal and determines which of the light emitting diode units are associated according to the brightness value of the lighting device;
wherein, when the first touch sensor and the second sensor simultaneously sense a touch, the microprocessor commands the power phase control circuit to turn on the lighting device according to the brightness value of the lighting device stored in the register and adjust the brightness of the lighting device to the brightness value and the indicating light module turns on the associated light emitting diode units and adjusts the brightness of the associated light emitting diode units according to the brightness value of the lighting device;
when only the first touch sensor senses a touch and the duration of the touch is less than a first predetermined touch time, the microprocessor controls the power phase control circuit to turn on the lighting device within a second predetermined time and the microprocessor controls the indicating light module to turn on the associated light emitting diode units and adjust the brightness of the associated light emitting diode units according to the brightness value of the lighting device; and
when only the second touch sensor senses a touch and the duration of the touch is less than a third predetermined touch time, the microprocessor controls the power phase control circuit to turn off the lighting device within a fourth predetermined time and the microprocessor controls the indicating light module to turn on the associated light emitting diode units and adjust the brightness of the associated light emitting diode units according to the brightness value of the lighting device.

10. The lighting control device according to claim 9, wherein,
when only the first touch sensor senses a touch and the duration of the touch is larger than or equal to the first predetermined touch time, the microprocessor controls the power phase control circuit to increase the brightness of the lighting device and then stores the increased brightness value in the register as the brightness value of the lighting device; and
when only the second touch sensor senses a touch and the duration of the touch is larger than or equal to the third predetermined touch time, the microprocessor controls the power phase control circuit to decrease the brightness of the lighting device and then stores the decreased brightness value in the register as the brightness value of the lighting device.

11. The lighting control device according to claim 9, wherein,
when the first touch sensor and the second sensor both do not sense a touch within a delay period, the microprocessor controls the indicating light module to decrease the brightness of the associated light emitting diode units to a brightness value for a power saving mode.

12. The lighting control module according to claim 9, wherein, when the first touch sensor senses a touch, the microprocessor commands the power phase control circuit to perform toggle switch control on the lighting device and, when the lighting device is changed from a state of turning on to a state of turning off, the indicating light module is turned on within a delay period and the brightness of the light emitting diode units in the indicating light module are dimmed while it is beyond the delay period.
